(19) United States
(12) Patent Application Publication
(10) Pub. No.: US 2019/0186602 A1
(43) Pub. Date: Jun. 20, 2019

(54) BALL VARIATOR CONTINUOUSLY VARIABLE TRANSMISSION

(71) Applicant: Dana Limited, Maumee, OH (US)

(72) Inventor: Sebastian J. Peters, Cedar Park, TX (US)

(21) Appl. No.: 16/224,913

(22) Filed: Dec. 19, 2018

Related U.S. Application Data
(60) Provisional application No. 62/608,127, filed on Dec. 20, 2017.

(51) Int. Cl. F16H 15/52; F16H 61/664; F16H 37/08

(52) U.S. Cl. CPC F16H 15/52; F16H 37/0853; F16H 61/6649

(57) ABSTRACT

Provided herein is a variator having a rotatable input shaft operably coupleable to a source of rotational power; a variator assembly having a first traction ring assembly and a second traction ring assembly in contact with a plurality of balls, wherein each ball of the plurality of balls has a tiltable axis of rotation, the variator assembly is coaxial with the rotatable input shaft; a first axial thrust bearing coupled to the rotatable input shaft and the first traction ring assembly; a bypass clutch coupled to the rotatable input shaft and configured to selectively engage the rotatable input shaft and the first traction ring assembly; a rotatable output shaft operably coupled to the rotatable input shaft and the second traction ring assembly; and a second axial thrust bearing coupled to the rotatable output shaft and the second traction ring assembly.

### RELATED APPLICATION

This application claims priority to and benefit from U.S. Provisional Application Ser. No. 62/608,127 filed on Dec. 20, 2017 which is incorporated herein by reference.

### BACKGROUND

A driveline including a continuously variable transmission allows an operator or a control system to vary a drive ratio in a stepless manner, permitting a power source to operate at its most advantageous rotational speed.

### SUMMARY

Provided herein is a variator including: a rotatable input shaft operably coupleable to a source of rotational power; a variator assembly having a first traction ring assembly and a second traction ring assembly in contact with a plurality of balls, wherein each ball of the plurality of balls has a tiltable axis of rotation, the variator assembly is coaxial with the rotatable input shaft; a first axial thrust bearing coupled to the rotatable input shaft and the first traction ring assembly; a bypass clutch coupled to the rotatable input shaft and configured to selectively engage the rotatable input shaft and the first traction ring assembly; a rotatable output shaft operably coupled to the rotatable input shaft and the second traction ring assembly; and a second axial thrust bearing coupled to the rotatable output shaft and the second traction ring assembly.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a schematic illustration of a variator having a bypass clutch coupled to a rotatable input shaft and a first traction ring assembly.

### DETAILED DESCRIPTION OF THE PREFERRED EMBODIMENTS

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, the preferred embodiments includes several novel features, no single one of which is solely responsible for its desirable attributes or which is essential to practicing the embodiments described.

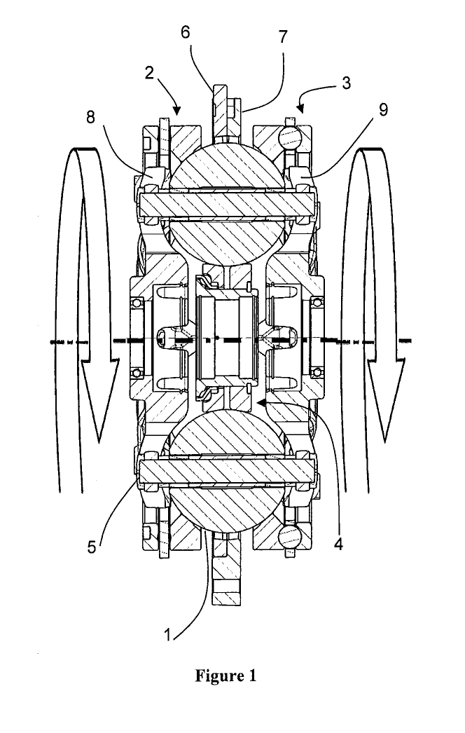

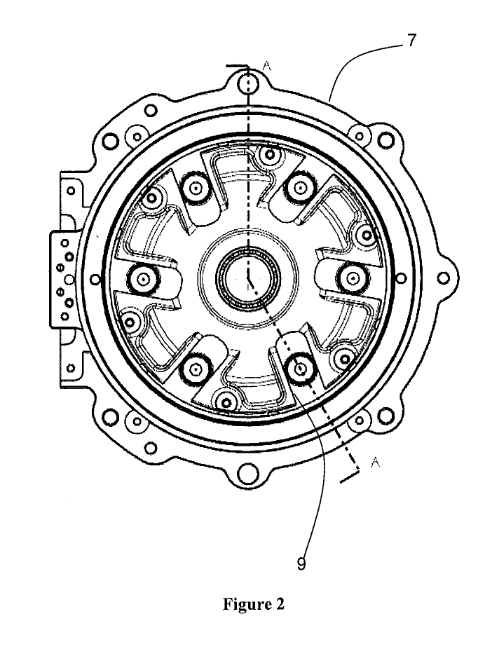

Provided herein are configurations of continuously variable transmissions (CVTs) based on a ball-type variators, also known as CVP, for continuously variable planetary. Basic concepts of a ball-type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface in contact with the balls, an input traction ring 2, an output traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, but are slightly different.

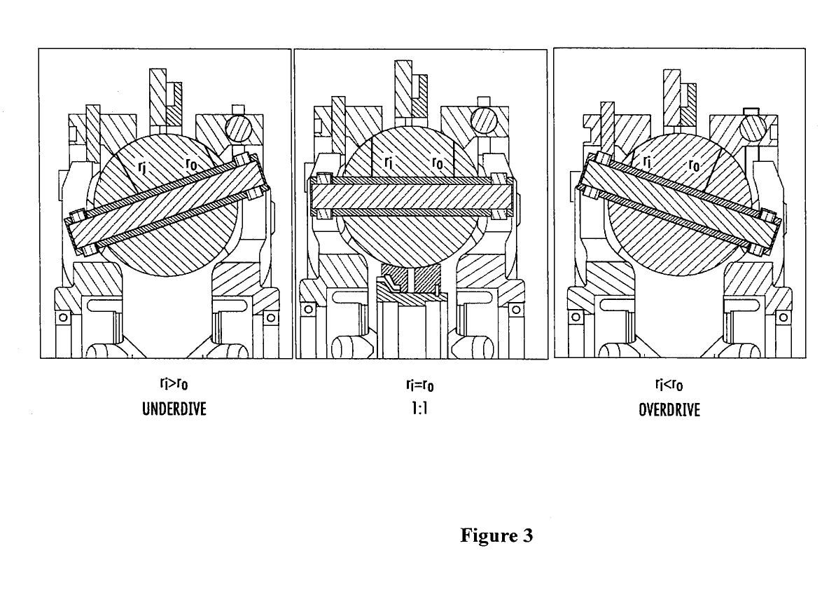

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to a variator and/or a CVT using generally spherical planets each having a tiltable axis of rotation that are adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

As used here, the terms “operationally connected,” “operationally coupled”, “operationally linked”, “operably connected”, “operably coupled”, “operably linked,” “operably coupleable” and like terms, refer to a relationship (mechanical, linkage, coupling, etc.) between elements whereby operation of one element results in a corresponding, following, or simultaneous operation or actuation of a second element. It is noted that in using said terms to describe the embodiments, specific structures or mechanisms that link or couple the elements are typically described. However, unless otherwise specifically stated, when one of said terms is used, the term indicates that the actual linkage or coupling take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these are typically understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here operate in both tractive and frictional applications. For example, in the embodiment where a CVT is used for a bicycle application, the CVT operates at times as a friction drive and at other times as a traction drive, depending on the torque and speed conditions present during operation.

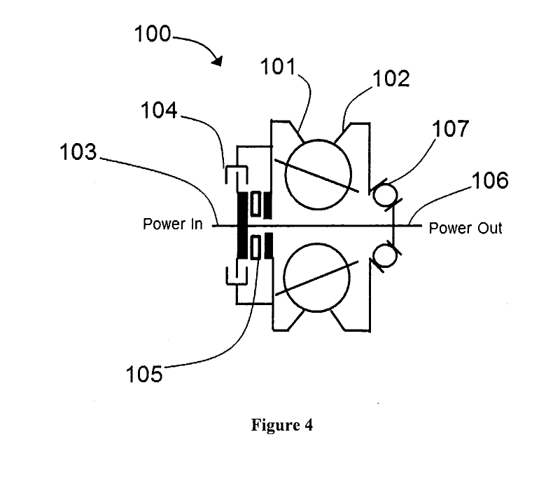

Referring now to FIG. 4, in some embodiments, a variator 100 is similar to the variator depicted in FIGS. 1-3. For description purposes, only the differences between the variator 100 and the variator of FIGS. 1-3 will be described. The variator 100 includes a first traction ring assembly 101 and a second traction ring assembly 102.

In some embodiments, a rotational power is transmitted to the variator 100 on an input shaft 103. The variator 100 includes a bypass clutch 104 operably coupled to the first traction ring assembly 101 and the input shaft 103.

In some embodiments, the bypass clutch 104 is optionally configured as a wet clutch, a one-way clutch, a synchronous clutch, or a mechanical diode.

In some embodiments, the input shaft 103 is coupled to an axial bearing 105. In some embodiments, the axial bearing 105 is a needle roller bearing, a bushing, an angular contact bearing, or other known axial thrust bearing. The axial bearing 105 is coupled to the first traction ring assembly 101. The axial bearing 105 is coupled to an output shaft 106.

In some embodiments, the input shaft 103 and the output shaft 106 are integral. The output shaft 106 is operably coupled to the second traction ring assembly 102 through a thrust bearing 107. In some embodiments, the thrust bearing 107 is an angular contact bearing or other known axial thrust bearing.

In some embodiments, rotational power is transmitted out of the variator 100 through the output shaft 106.

In some embodiments, rotational power is transmitted out of the variator 100 through the second traction ring assembly 102. It should be appreciated that the variator 100 is optionally coupled to fixed or variable ratio gearing through the output shaft 106.

During operation of the variator 100, power is transmitted to the variator 100 through the input shaft 103. When the bypass clutch 104 is engaged, the input power is directed to the first traction ring assembly 101 and the input shaft 103 and effectively bypasses the variator 100. When the bypass clutch 104 is disengaged, power is transmitted from the input shaft 103 to the output shaft 106, while the first traction ring assembly 101 and the second traction ring assembly 102 do not transmit power, thereby reducing losses associated with spinning of the first traction ring assembly 101 and the second traction ring assembly.

In some embodiments, the variator 100 is connected to a source of rotational power including, but not limited to, an internal combustion engine or a motor/generator.

In some embodiments, the output power of the variator 100 is optionally configured to couple to front wheel drive assemblies, rear wheel drive assemblies or both depending on the desired vehicle architecture.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practice. It is intended that the following claims define the scope of the preferred embodiments and that methods and structures within the scope of these claims and their equivalents be covered thereby.

What is claimed is:

1. A variator comprising:
a rotatable input shaft operably coupleable to a source of rotational power;
a variator assembly having a first traction ring assembly and a second traction ring assembly in contact with a plurality of balls, wherein each ball of the plurality of balls has a tiltable axis of rotation, the variator assembly is coaxial with the rotatable input shaft;
a first axial thrust bearing coupled to the rotatable input shaft and the first traction ring assembly;
a bypass clutch coupled to the rotatable input shaft and configured to selectively engage the rotatable input shaft and the first traction ring assembly;
a rotatable output shaft operably coupled to the rotatable input shaft and the second traction ring assembly; and
a second axial thrust bearing coupled to the rotatable output shaft and the second traction ring assembly.

2. The variator of claim 1 further comprising an idler assembly coupled to each ball and positioned radially inward of the first traction ring assembly and the second traction ring assembly.

3. The variator of claim 1, wherein the second traction ring assembly is configured to transmit a rotational power out of the variator.

4. The variator of claim 1, wherein the first traction ring assembly is configured to receive a rotational power.
